(19) United States
(12) Patent Application Publication
(10) Pub. No.: US 2024/0377063 A1
(43) Pub. Date: Nov. 14, 2024

(54) FLARE STACK AND SYSTEM COMPRISING SAME

(71) Applicant: IHI Corporation, Tokyo (JP)

(72) Inventors: Soichiro KATO, Tokyo (JP); Shintaro ITO, Tokyo (JP)

(73) Assignee: IHI Corporation, Tokyo (JP)

(21) Appl. No.: 18/782,287

(22) Filed: Jul. 24, 2024

Related U.S. Application Data
(63) Continuation of application No. PCT/JP2022/042710, filed on Nov. 17, 2022.

(30) Foreign Application Priority Data
Feb. 10, 2022 (JP) 2022-019568

(51) Int. Cl. F23G 7/08; C01B 3/04

(52) U.S. Cl. CPC F23G 7/085; C01B 3/047; F23G 2207/101; F23G 2209/14

(57) ABSTRACT

A flare stack includes a main burner to which ammonia is supplied, a pilot burner to which ammonia is supplied, a first catalyst that is provided upstream of the pilot burner in a flow of ammonia and that decomposes the ammonia supplied to the pilot burner to reformed fuel including hydrogen, and a heater that heats the first catalyst.

### CROSS REFERENCE TO RELATED APPLICATIONS

This application is a continuation application of International Application No. PCT/JP2022/042710, filed on Nov. 17, 2022, which claims priority to Japanese Patent Application No. 2022-19568 filed on Feb. 10, 2022, the entire contents of which are incorporated herein by reference.

### BACKGROUND ART

### Technical Field

The present disclosure relates to a flare stack and a system comprising the flare stack.

Ammonia is used in a variety of systems. For example, Patent Literature 1 discloses a gas turbine that uses ammonia as fuel. The ignitability of ammonia is known to be poor. Accordingly, the gas turbine of Patent Literature 1 comprises a reformer that reforms ammonia into a reformed fuel including hydrogen in order to improve the stability of ammonia combustion during startup. The reformer includes a heater that heats ammonia and a catalyst that decomposes ammonia into hydrogen and nitrogen. The reformed fuel is supplied to an area near a spark plug from a reformed-fuel nozzle that is provided separately from a main-fuel nozzle.

### CITATION LIST

### Patent Literature

Patent Literature 1: JP 2021-127861 A

### SUMMARY

### Technical Problem

Ammonia may be stored in a tank in a liquid state. However, heat from an outside causes the ammonia in the tank to vaporize. For example, in order to prevent excessive pressure in the tank due to vaporized ammonia, a BOG (Boil Off Gas) compressor may be used to return ammonia to a liquid state. However, the BOG compressor may not be available in an emergency, for example, a power failure. In this case, ammonia may be combusted by a flare stack. If ammonia can be burned quickly by the flare stack, the vaporized ammonia can be quickly removed from the tank, thereby improving the safety of a system using ammonia.

An object of the present disclosure is to provide a flare stack and a system comprising the flare stack that can burn ammonia quickly.

### Solution to Problem

A flare stack according to an aspect of the present disclosure includes a main burner to which ammonia is supplied, a pilot burner to which ammonia is supplied, a first catalyst that is provided upstream of the pilot burner in a flow of ammonia and that decomposes the ammonia supplied to the pilot burner into reformed fuel including hydrogen, and a heater that heats the first catalyst.

The pilot burner may be arranged such that a flame of the pilot burner heats the first catalyst.

The flare stack may include a sensor that measures the temperature of the first catalyst and a controller that is communicatively connected to the heater and the sensor, wherein the controller may be configured to turn off the heater when the temperature of the first catalyst received from the sensor is equal to or above a predetermined temperature.

The flare stack may include a second catalyst that is provided upstream of the main burner in a flow of ammonia and that decomposes the ammonia supplied to the main burner into reformed fuel including hydrogen.

The second catalyst may be arranged at a position heated by radiation from a flame of the main burner.

Another aspect of the present disclosure is a system using ammonia, including the flare stack described above.

### Effects

According to the present disclosure, ammonia can be burned quickly.

### BRIEF DESCRIPTION OF DRAWINGS

FIG. 1 is a schematic diagram of a system according to an embodiment.

FIG. 2 is a schematic cross-sectional view showing a flare stack according to a first embodiment.

FIG. 3 is a flowchart showing an operation of the flare stack according to the first embodiment.

FIG. 4 is a flowchart showing another operation of the flare stack according to the first embodiment.

FIG. 5 is a schematic cross-sectional view showing a flare stack according to a second embodiment.

FIG. 6 is a schematic cross-sectional view showing a flare stack according to a third embodiment.

### DESCRIPTION OF EMBODIMENTS

Embodiments of the present disclosure will be described in detail below with reference to the accompanying drawings. Specific dimensions, materials, and numerical values described in the embodiments are merely examples for a better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

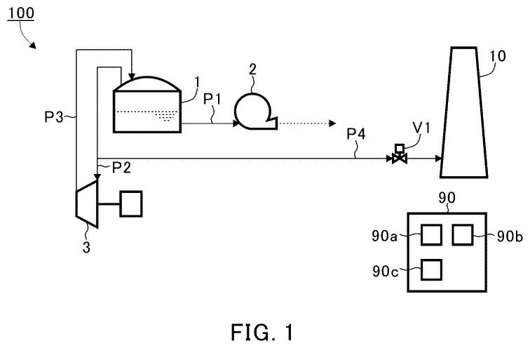

FIG. 1 is a schematic diagram of a system 100 according to an embodiment. For example, the system 100 comprises a tank 1, a pump 2, a Boil Off Gas (BOG) compressor 3, and a flare stack 10. The system 100 may further comprise other components, such as, for example, an abatement tank. Furthermore, the system 100 may not necessarily comprise one or more of the above-described components. The flare stack 10 also includes a controller 90.

The system 100 may use ammonia stored in the tank 1 for various purposes. For example, the system 100 may comprise a boiler that burns ammonia and a steam turbine that is operated by steam generated by the boiler. Furthermore, for example, the system 100 may comprise a combustor that burns ammonia and a gas turbine that is operated by gas generated by the combustor. In addition, the system 100 may be a plant that uses ammonia as a material to manufacture a product. The system 100 is not limited thereto, and May include various facilities that use ammonia.

The tank 1 stores ammonia. Specifically, the tank 1 stores liquid ammonia. The tank 1 is connected to a pump 2 by piping P1. The liquid ammonia stored in the tank 1 is supplied to the pump 2 via the piping P1. The liquid ammonia is pressurized by the pump 2, and supplied to a facility (not shown) that uses ammonia. For example, the ammonia may be supplied in a liquid state to the facility that uses ammonia. Furthermore, the system 100 may comprise a vaporizer, and the ammonia may be supplied in a gaseous state to the facility that uses ammonia.

The liquid ammonia in the tank 1 may be vaporized due to external heat. The vaporized ammonia may increase the pressure in the tank 1. Accordingly, the system 100 comprises the BOG compressor 3 and the flare stack 10 to curb the pressure increase in the tank 1. The tank 1 may be provided with a sensor (not shown) to measure the pressure in the tank 1.

The BOG compressor 3 is connected to the tank 1 by piping P2. The vaporized ammonia in the tank 1 is supplied to the BOG compressor 3 via the piping P2. The BOG compressor 3 compresses the vaporized ammonia and returns the ammonia to liquid. The liquid ammonia is returned from the BOG compressor 3 to the tank 1 via piping P3. This configuration prevents excessive pressure in the tank 1 and reduces the amount of ammonia to be disposed of.

The flare stack 10 is connected to the tank 1 by piping P4. The vaporized ammonia in the tank 1 is supplied to the flare stack 10 via the piping P4. The flare stack 10 burns the vaporized ammonia and releases exhaust gas from which the ammonia is removed or reduced below a regulatory value. For example, the flare stack 10 may be used when the BOG compressor 3 is not available in an emergency such as a power failure. The flare stack 10 may also be used when the amount of vaporized ammonia is so large that the BOG compressor 3 cannot adequately process the vaporized ammonia. Situations in which the flare stack 10 may be used are not limited thereto, and the flare stack 10 may be used in other situations. The flare stack 10 will be described in more detail below.

The controller 90 controls the flare stack 10. The controller 90 may control the system 100 in whole or in part. The controller 90 includes components such as, for example, a processor 90a, a memory 90b, and a connector 90c, and these components are connected to each other via buses. For example, the processor 90a includes a central processing unit (CPU). For example, the memory 90b includes a hard disk, a ROM in which programs are stored, and a RAM as a work area. The controller 90 is communicatively connected to each component of the system 100 by wire or wirelessly via the connector 90c. For example, the controller 90 may further include other components such as a display device, such as an LCD or touch panel, and an input device, such as a keyboard, button or touch panel. For example, operations of the controller 90 described below may be realized by executing programs stored in the memory 90b on the processor 90a.

Next, the flare stack 10 is described in detail.

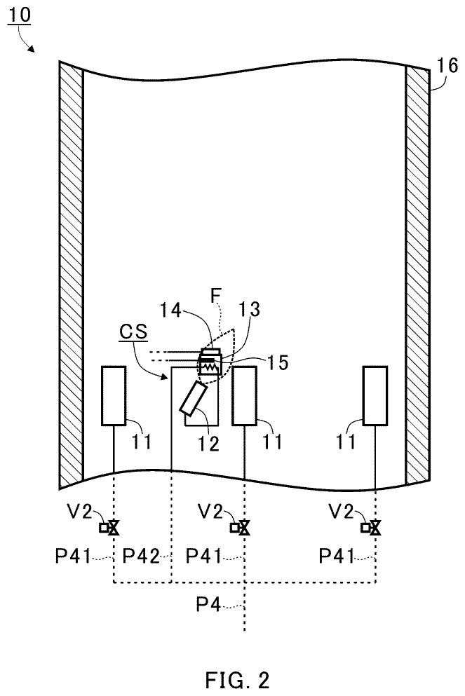

FIG. 2 is a schematic cross-sectional view showing the flare stack 10 according to a first embodiment. In FIG. 2, only a part of the flare stack 10 is shown for better understanding. For example, the flare stack 10 includes a plurality of main burners 11, a pilot burner 12, a first catalyst 13, a heater 14, a sensor 15, and a radiation shield 16. The flare stack 10 may further include other components. The radiation shield 16 is not essential, depending on the shape of the flare stack 10.

Each of the main burners 11 and the pilot burner 12 burns the vaporized ammonia supplied from the tank 1. FIG. 2 shows three main burners 11, but the number of main burners 11 is not limited thereto and may be two or four or more. Furthermore, in another embodiment, the flare stack 10 may include a single main burner 11.

For example, the plurality of main burners 11 are arranged in any pattern, such as circular or matrix-like. For example, the pilot burner 12 is associated with a specific main burner 11, e.g., the central main burner 11 in FIG. 2, so as to ignite ammonia emitted from the specific main burner 11.

For example, the main burner 11 is configured to operate when the BOG compressor 3 is not available in an emergency, such as a power failure. Furthermore, for example, the main burner 11 is configured to operate when the amount of vaporized ammonia is so large that the BOG compressor 3 cannot adequately process the vaporized ammonia. In other words, the main burner 11 is configured not to operate during a first period when it is not necessary to burn ammonia in the main burner 11, and is configured to operate only during a second period when it is necessary to burn ammonia in the main burner 11.

In contrast, the pilot burner 12 is configured to operate constantly throughout the first period and the second period described above to always ensure a pilot light for igniting ammonia emitted from the main burner 11. For example, the amount of ammonia supplied to the pilot burner 12 is less than the amount of ammonia supplied to the main burner 11 during the second period. For example, the pilot burner 12 may include a spark plug or the like (not shown) to initially ignite ammonia supplied from the tank 1 to the pilot burner 12.

For example, the above piping P4 connecting the tank 1 to the flare stack 10 may be branched into a plurality of pipes P41 connected to the main burners 11 and a pipe P42 connected to the pilot burner 12. The main burners 11 are supplied with ammonia from the tank 1 via the piping P4 and P41. The pilot burner 12 is supplied with ammonia from the tank 1 via the piping P4 and P42. In FIG. 1, the pipes P41 and P42 are connected to the tank 1 via the piping P4, but in another embodiment, the pipes P41 and P42 may be directly connected to the tank 1 without the piping P4. The configuration of the piping P41 and P42 is not limited thereto, and other configurations may be used.

Referring to FIG. 1, the flare stack 10 includes a valve V1 on the piping P4 to control a flow rate of ammonia supplied from the tank 1 to the main burners 11 and the pilot burner 12. The valve V1 may be communicatively connected to the controller 90 by wire or wirelessly, and may be controlled by the controller 90.

For example, the controller 90 adjusts the valve V1 to a first opening degree that is necessary to ensure only the amount of ammonia supplied to the pilot burner 12, during the first period when it is not necessary to burn ammonia in the main burners 11. Furthermore, the controller 90 adjusts the valve V1 to a second opening degree that is greater than the first opening degree, during the second period when it is necessary to burn ammonia in the main burners 11.

Referring to FIG. 2, each of the pipes P41 may be provided with a valve V2 to control a flow rate of ammonia supplied from the tank 1 to the main burners 11. The valves V2 may be communicatively connected to the controller 90 by wire or wirelessly, and may be controlled by the controller 90.

For example, the controller 90 may close the valves V2 during the first period described above. In this case, ammonia from the tank 1 is supplied only to the pilot burner 12. Furthermore, the controller 90 may open the valves V2 during the second period described above. In this case, ammonia from the tank 1 is supplied to both the main burners 11 and the pilot burner 12. For example, the controller 90 may selectively open only a required valve V2 out of the plurality of valves V2, depending on the amount of ammonia supplied from the tank 1.

For example, in another embodiment, an additional valve may be provided on the piping P42. In still another embodiment, the valve V1 may be provided on the piping P42 instead of the piping P4. In this case, the valve V1 only adjusts the flow rate of ammonia supplied to the pilot burner 12. In still another embodiment, the valve V1 may not be provided.

In the piping P42, the first catalyst 13 is provided upstream of the pilot burner 12 in a flow of ammonia. The first catalyst 13 decomposes the ammonia passing through the piping P42 and supplied to the pilot burner 12 into a reformed fuel including hydrogen and nitrogen. The first catalyst 13 can be, for example, a catalyst that decomposes gaseous ammonia into hydrogen and nitrogen and can be, for example, Ni/Al₂O₃ and Ru/Pr₆O₁₁. For example, the first catalyst 13 can be supported on a carrier that is accommodated in a housing.

The pilot burner 12 is arranged at a position and in an orientation such that a flame F of the pilot burner 12 can heat both an area near a nozzle of the corresponding main burner 11, and the first catalyst 13. Specifically, the piping P42 includes a curved section CS such that a nozzle of the pilot burner 12 is directed to both the area near the nozzle of the main burner 11, and a position where the first catalyst 13 is provided. The section CS may have any shape as long as the nozzle of the pilot burner 12 is directed to both the area near the nozzle of the main burner 11, and the position where the first catalyst 13 is provided.

The heater 14 heats the first catalyst 13 at least to a temperature at which the first catalyst 13 starts reforming. For example, the heater 14 may be operated by electric power. For example, the heater 14 may be attached to the housing that accommodates the carrier of the first catalyst 13. Alternatively or additionally, the heater 14 may provide electric power to the carrier of the first catalyst 13 to heat the first catalyst 13. The heater 14 may be communicatively connected to the controller 90 by wire or wirelessly, and may be controlled by the controller 90.

The sensor 15 measures the temperature of the first catalyst 13. The sensor 15 can be a variety of temperature sensors, for example, a thermocouple. For example, the sensor 15 may be fixed to the carrier of the first catalyst 13. Alternatively or additionally, the sensor 15 may be attached to the housing that accommodates the carrier of the first catalyst 13. The sensor 15 may be communicatively connected to the controller 90 by wire or wirelessly, and may transmit measurement data to the controller 90.

The radiation shield 16 is a wall of or a part of a wall of the flare stack 10. For example, the radiation shield 16 has a substantially cylindrical shape. The radiation shield 16 surrounds the main burners 11 and the pilot burner 12 so that flames from the main burners 11 and the pilot burner 12 are not exposed to an outside of the flare stack 10. The radiation shield 16 includes a heat-insulating material to prevent heat from the flames from leaking to the outside of the flare stack 10.

Next, an operation of the flare stack 10 is described.

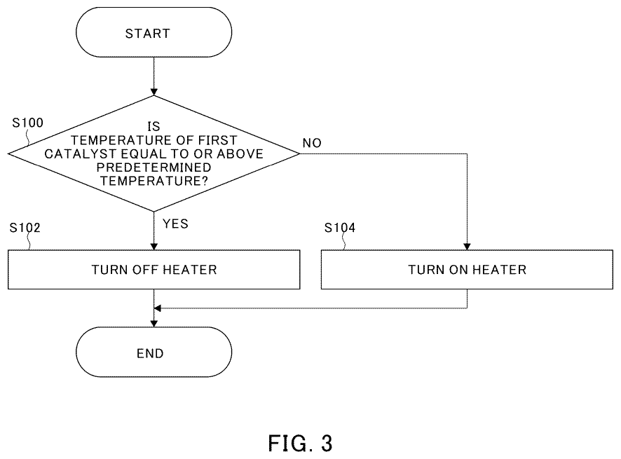

FIG. 3 is a flowchart showing an operation of the flare stack 10 according to the first embodiment. Prior to the operation shown in FIG. 3, ammonia is supplied to the pilot burner 12 in the flare stack 10, and the flame F is formed by the pilot burner 12. Furthermore, for example, the operation shown in FIG. 3 may always be repeated in a predetermined cycle, or may be repeated in a predetermined cycle until the first catalyst 13 is heated to the temperature at which reforming begins.

The processor 90a of the controller 90 determines whether or not the temperature of the first catalyst 13 is equal to or above a predetermined temperature (step S100). Specifically, the processor 90a determines whether or not the temperature received from the sensor 15 is equal to or above the temperature at which the first catalyst 13 starts reforming (e.g., 300° C. to 600° C.).

When the temperature of the first catalyst 13 is equal to or above the predetermined temperature in the step S100 (YES), the processor 90a turns off the heater 14 (step S102), and terminates the operation. When the heater 14 is already turned off, the processor 90a maintains that state.

When the temperature of the first catalyst 13 is not equal to or above the predetermined temperature in the step S100 (NO), the processor 90a turns on the heater 14 (step S104), and terminates the operation. When the heater 14 is already turned on, the processor 90a maintains that state.

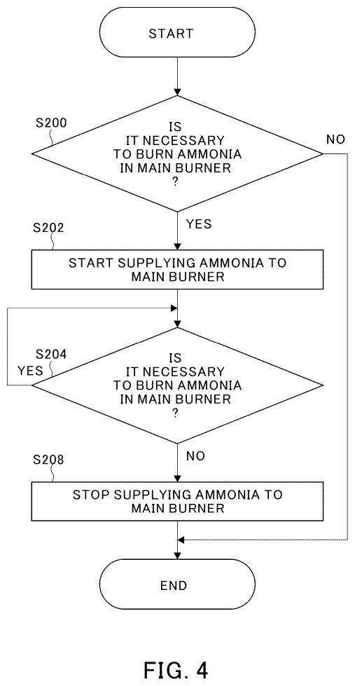

FIG. 4 is a flowchart showing another operation of the flare stack 10 according to the first embodiment. Prior to the operation shown in FIG. 4, ammonia is supplied to the pilot burner 12 in the flare stack 10, and the flame F is formed by the pilot burner 12. Furthermore, prior to the operation shown in FIG. 4, there is no emergency, i.e., it is not necessary to burn ammonia in the main burner 11, and ammonia is not supplied to the main burner 11 (first period). For example, the operation shown in FIG. 4 may always be repeated in a predetermined cycle. Furthermore, during the operation shown in FIG. 4, the operation shown in FIG. 3 may be executed in parallel.

The processor 90a of the controller 90 determines whether or not it is necessary to burn ammonia in the main burner 11 (step S200). Specifically, for example, the processor 90a determines whether or not the situation is an emergency, such as a power failure, a failure of the BOG compressor 3, or the BOG compressor 3 not being able to adequately process the vaporized ammonia.

When it is determined that there is no need to burn ammonia in the main burner 11 in the step S200 (NO), the processor 90a terminates the operation.

When it is determined that ammonia has to be burned in the main burner 11 in the step S200 (YES, i.e., the second period), the processor 90a starts supplying ammonia to the main burner 11 (step S202). Specifically, the processor 90a switches the valve V1 from the first opening degree that is required to ensure only the amount of ammonia supplied to the pilot burner 12, to the second opening degree that is larger than the first opening degree. The processor 90a also opens the valve V2 of the main burner 11 with which the pilot burner 12 is associated. As such, ammonia is supplied to the main burner 11. The ammonia supplied to the main burner 11 is quickly ignited and burned by the flame F of the pilot burner 12. Depending on the amount of ammonia supplied from the tank 1, the valve V2 of another main burner 11 may also be opened. The ammonia supplied to another main burner 11 is also ignited by a propagating flame.

Next, the processor 90a determines again whether or not it is necessary to burn ammonia in the main burner 11 (step S204). Specifically, for example, the processor 90a determines whether or not an emergency is ongoing.

When it is determined that ammonia has to be burned in the main burner 11 in the step S204 (YES), the processor 90a repeats the step S204 until the emergency is over.

When it is determined that there is no need to burn ammonia in the main burner 11 in the step S204 (NO), the processor 90a stops supplying ammonia to the main burner 11 (step S208) and terminates the operation. As such, the flame of the main burner 11 is extinguished. In contrast, the flame F of the pilot burner 12 is continuously maintained.

The flare stack 10 and the system 100 comprising the flare stack 10 as described above include the main burners 11 to which ammonia is supplied, the pilot burner 12 to which ammonia is supplied, the first catalyst 13 that is provided upstream of the pilot burner 12 in the flow of ammonia and that reforms the ammonia supplied to the pilot burner 12 into the reformed fuel including hydrogen, and the heater 14 that heats the first catalyst 13. According to such a configuration, the ammonia supplied to the pilot burner 12 is decomposed into the reformed fuel, by heating the first catalyst 13 with the heater 14 to the temperature at which reforming begins. The reformed fuel including hydrogen ignites more quickly than ammonia. Accordingly, the ammonia supplied to the pilot burner 12 can be burned quickly. Furthermore, the ammonia supplied to the main burner 11 can be burned quickly by using the flame F of the pilot burner 12 as a pilot light. Thus, ammonia can be burned quickly.

Furthermore, in the flare stack 10, the pilot burner 12 is arranged so that the flame F of the pilot burner 12 heats the first catalyst 13. According to such a configuration, the pilot burner 12 can heat the first catalyst 13 by its own flame F, thus reducing the energy used by the heater 14.

Furthermore, the flare stack 10 includes the sensor 15 that measures the temperature of the first catalyst 13 and the controller 90 that is communicatively connected to the heater 14 and the sensor 15, wherein the controller 90 is configured to turn off the heater 14 when the temperature of the first catalyst 13 received from the sensor 15 is equal to or above the predetermined temperature. When the temperature of the first catalyst 13 is equal to or above the temperature at which reforming begins, the first catalyst 13 continues to reform the ammonia supplied to the pilot burner 12 even if the heater 14 is turned off, and thus the flame F of the pilot burner 12 also continues to heat the first catalyst 13. Thus, according to the above configuration, the energy used by the heater 14 can be further reduced. Also, according to the above configuration, the pilot burner 12 continues to operate without being heated by the heater 14, so that the flare stack 10 can be operated even in the event of a power failure, for example.

Next, flare stacks according to other embodiments are described.

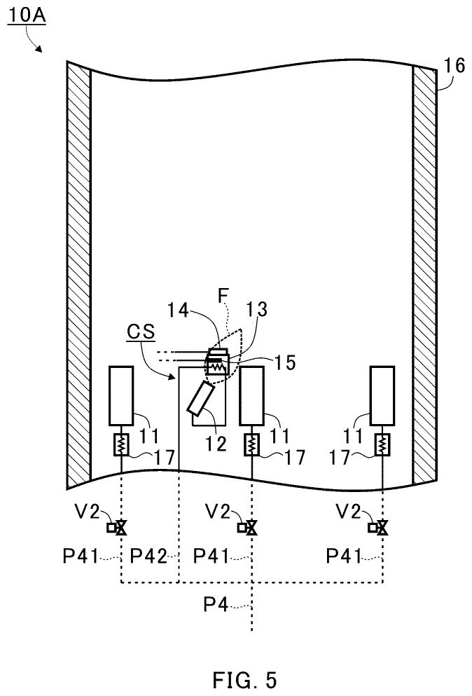

FIG. 5 is a schematic cross-sectional view of a flare stack 10A according to a second embodiment. The flare stack 10A differs from the flare stack 10 of the first embodiment in that it further includes second catalysts 17. The flare stack 10A may be the same as the flare stack 10 in other respects.

In each of the pipes P41, the second catalyst 17 is provided upstream of the main burner 11 in a flow of ammonia. The second catalyst 17 decomposes the ammonia that passes through the pipe P41 and that is supplied to the main burner 11 into reformed fuel including hydrogen and nitrogen. The second catalyst 17 can be, for example, a catalyst that decomposes gaseous ammonia into hydrogen and nitrogen and can be, for example, Ni/Al₂O₃ and Ru/Pr₆O₁₁. For example, the second catalyst 17 may be supported on a carrier that is accommodated in a housing.

The second catalyst 17 is arranged at a position heated by radiation from the flame of the main burner 11. Specifically, for example, when the main burner 11 is operating, the interior of the radiation shield 16 is maintained above the temperature at which the second catalyst 17 starts reforming. Thus, in each pipe P41, the second catalyst 17 can be provided at a position inside the radiation shield 16. A heater and a sensor may not necessarily be provided for the second catalyst 17.

The flare stack 10A as described above has the same effects as those of the flare stack 10 of the first embodiment. Furthermore, the flare stack 10A includes the second catalyst 17 that is provided upstream of the main burner 11 in the flow of ammonia and that decomposes the ammonia supplied to the main burner 11 into the reformed fuel including hydrogen. According to such a configuration, the ammonia supplied to the main burner 11 can also be decomposed into the reformed fuel including hydrogen. Thus, the stability of combustion can be improved.

Furthermore, in the flare stack 10A, the second catalyst 17 is arranged at the position heated by radiation from the flame of the main burner 11. According to such a configuration, after the main burner 11 starts operating, the second catalyst 17 is heated by radiation from the flame of the main burner 11 without a heater. Accordingly, a heater for heating the second catalyst 17 to the temperature at which reforming begins can be omitted.

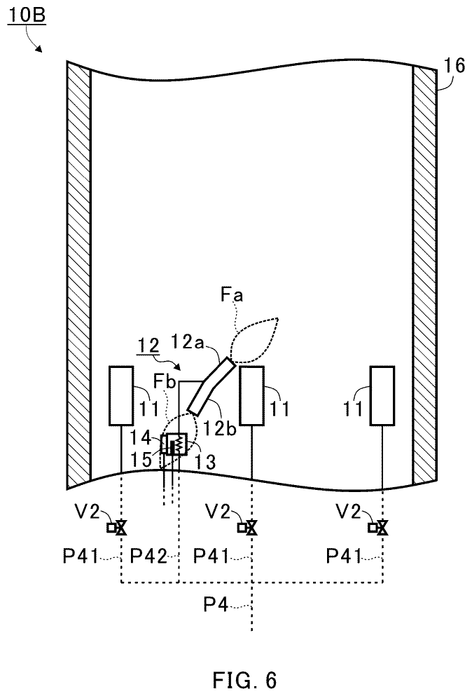

FIG. 6 is a schematic cross-sectional view of a flare stack 10B according to a third embodiment. The flare stack 10B differs from the flare stack 10 of the first embodiment in that the pilot burner 12 includes two nozzles. Accordingly, the positions of the first catalyst 13, the heater 14, and the sensor 15 have been changed. The flare stack 10B may be the same as the flare stack 10 in other respects.

The pilot burner 12 includes a first nozzle 12a and a second nozzle 12b. Thus, the pilot burner 12 forms two flames Fa and Fb. The first nozzle 12a is arranged at a position and in an orientation such that the flame Fa of the first nozzle 12a can heat the area near the nozzle of the corresponding main burner 11. The second nozzle 12b is arranged at a position and in an orientation such that the flame Fb of the second nozzle 12b can heat the first catalyst 13.

The flare stack 10B as described above has the same effects as those of the flare stack 10 of the first embodiment. Furthermore, in the flare stack 10B, the pilot burner 12 includes a plurality of nozzles including the first nozzle 12a of which flame Fa heats the area near the nozzle of the main burner 11 and the second nozzle 12b of which flame Fb heats the first catalyst 13. According to such a configuration, the shape of the piping 42 can be simplified.

Although the embodiments of the present disclosure have been described above with reference to the accompanying drawings, the present disclosure is not limited thereto. It is obvious that a person skilled in the art can conceive of various examples of variations or modifications within the scope of the claims, which are also understood to belong to the technical scope of the present disclosure.

The present disclosure can improve safety of ammonia use leading to reduction of CO₂ emissions, thus contributing to Sustainable Development Goal (SDGs), Goal 7: “Ensure access to affordable, reliable, sustainable and modern energy,” for example.

What is claimed is:

1. A flare stack comprising:
a main burner to which ammonia is supplied;
a pilot burner to which ammonia is supplied;
a first catalyst that is provided upstream of the pilot burner in a flow of ammonia and that decomposes the ammonia supplied to the pilot burner into reformed fuel including hydrogen; and
a heater that heats the first catalyst.

2. The flare stack according to claim 1, wherein the pilot burner is arranged such that a flame of the pilot burner heats the first catalyst.

3. The flare stack according to claim 2, further comprising:
a sensor that measures the temperature of the first catalyst; and
a controller that is communicatively connected to the heater and the sensor,
wherein the controller is configured to turn off the heater when the temperature of the first catalyst received from the sensor is equal to or above a predetermined temperature.

4. The flare stack according to claim 1, further comprising a second catalyst that is provided upstream of the main burner in a flow of ammonia and that decomposes the ammonia supplied to the main burner into reformed fuel including hydrogen.

5. The flare stack according to claim 4, wherein the second catalyst is arranged at a position heated by radiation from a flame of the main burner.

6. A system using ammonia, comprising the flare stack according to claim 1.
